(19) United States
(12) Patent Application Publication
(10) Pub. No.: US 2008/0133423 A1
(43) Pub. Date: Jun. 5, 2008

(54) Multimode negotiation in a networking environment

(75) Inventors: Sadashiv Adiga, Hercules, CA (US); Milind Gadre, Fremont, CA (US); Neil Wixsom, Emeryville, CA (US)

Correspondence Address: Intellevate, P.O. Box 52050, Minneapolis, MN, 55402, US

(73) Assignee: EcPlatforms, Inc., Hercules, CA (US)

(21) Appl. No.: 10/970,690

(22) Filed: Oct. 21, 2004

Related U.S. Application Data
(62) Division of application No. 09/717,783, filed on Nov. 21, 2000, now abandoned.
(60) Provisional application No. 60/200,815, filed on Apr. 28, 2000.

(51) Int. Cl. G06Q 99/00; G06F 17/30

(52) U.S. Cl. 705/80; 707/103 R; 707/E17.045

(57) ABSTRACT

The invention provides a technique for computerized multi-variable negotiation in networking environment. A user initiates a transaction by identifying a variety of parameters, specifying which parameters may be modified, and indicating limits of acceptable modification. This latter feature is particularly important with respect to entertaining counteroffers. The initiator of a negotiation selects the parties with whom they wish to negotiate. The parameters describing a transaction are sent to negotiating parties who may submit bids. The bids may contain new terms created by altering one or more of the parameters. These bids are summarized and presented to the initiator. The initiator of the negotiation reviews the bids and (1) eliminates bids from consideration, 2) accepts a bid, or (3) selects bids for advanced negotiations. This process continues until the parties decide to close the deal. A history of each involved in a negotiation is maintained in a database.

### RELATED APPLICATION

This application claims the priority of a provisional application Ser. No. 60/200,815, attorney docket number 182.1001.01, filed on Apr. 28, 2000, Express Mail Mailing Number EL 524 781 340 US.

### BACKGROUND OF THE INVENTION

1. Field of the Invention

This invention relates to multi-variable, automated negotiation.

2. Related Art

One aspect of the Internet that has become popular is automated single-variable negotiation. Many web-based auction houses apply some variation of single-variable negotiation techniques for goods or services. For example, in the known art of LTL (less than total load) coordination, shippers may visit a commercial web site, describe a shipment and solicit bids from LTL carriers. The bids are reviewed and the lowest bids are selected for presentation to the shipper. In this example, the single variable that is negotiated is price.

One drawback to these single-variable negotiating agents is their relative inflexibility. This inflexibility eliminates possible consideration of other parameters, such as occurs in the give-and-take involved in face-to-face negotiation. For example, a business wishing to have goods transported may be willing to pay more than the lowest bid if the carrier can transport the goods quickly and perform an additional service such as providing shipping containers or offloading the goods to another carrier such as a ship. In a second example, a carrier might make a lower bid if they knew that the business would be willing to have their goods transported part of the way to a final destination. In such circumstances, single-variable negotiation is undesirable because it creates unnecessary constraints on the negotiation process.

Accordingly, it would be desirable to provide an improved technique for evaluating multiple parameters that may be of importance to negotiating parties. This is achieved in an embodiment of the invention in which the various parties to a negotiation specify one or more parameters that are of importance. A computerized communication system presents these parameters to prospective parties who evaluate and respond to the sum total of parameters. The communication system includes a technique for presentation that allows aggregation and summarization of these possible outcomes to the parties, thereby enabling them to dynamically negotiate in real time.

The invention provides an enabling technology for multi-variable negotiation, to obtain substantial advantages and capabilities that are novel and non-obvious in view of the known art. Examples described below relate to commercial shipping negotiations, but the invention is broadly applicable to many different types of commercial and personal negotiations such as leases and security trades.

### SUMMARY OF THE INVENTION

The invention provides a technique for computerized multi-variable negotiation in networking environment.

In a first aspect of the invention, a user initiates a transaction by identifying a variety of parameters. These parameters can include those attributes which are unique to a particular transaction, as well as attributes that are common to most transactions, such as price, quantity, date(s) of performance and other customary terms. The user can also (1) specify which parameters may be modified by the parties to the negotiations and (2) provide a range of values indicating the limits of acceptable modification. This latter feature is particularly important with respect to entertaining counteroffers. In a preferred embodiment, a list of suggested attributes is generated by a computer program. In other preferred embodiments, some of attributes may be generated by the initiator of the negotiation.

In a second aspect of the invention, the initiator of a negotiation selects the parties with whom they wish to negotiate. In a preferred embodiment, this is accomplished by reviewing a directory of prospective negotiating partners. The initiator of a negotiation may chose to (1) limit their negotiations to select parties included in the directory, (2) negotiate with all parties in the directory that fit a particular profile (for example, all transcontinental hazardous waste haulers with tanker cars) or (3) select entities that are not included in the directory. All of the parameters describing a desired transaction are sent to the prospective negotiating parties selected by the initiator of the negotiation. In a preferred embodiment, the initiating party can specify whether the parameters describing a desired transaction may be forwarded to other prospective negotiating parties not originally designated.

In a third aspect of the invention, the prospective negotiating parties may submit bids. If the initiator of the negotiation specified that certain parameters could be modified, the bids may contain new terms created by altering one or more of the parameters. These bids are summarized and presented to the initiator of the negotiations. Additional data such as chat, text messages, voice messages and/or graphics may also be included. In a preferred embodiment, these prospective negotiating parties may elect to remain anonymous.

In a fourth aspect of the invention, the initiator of the negotiation reviews the bids. The initiator of the negotiation may (1) eliminate some, all or none of the bids from further consideration and (2) accept a bid (thereby closing the deal) or select one or more of the bids for more advanced negotiations. In a preferred embodiment, these advanced negotiations may include a transaction in which the bids selected for more advanced negotiations may be further aggregated, so as to comprise a possible package deal or a variant thereof. In addition to further aggregation, the initiator of the negotiation may also alter some of the parameters and present them to those parties selected for advanced negotiations. This process of negotiating continues until such time that the parties decide to close the deal.

In a fifth aspect of the invention, a history of every transaction involved in a negotiation is maintained in a database. This database includes a history of all negotiations, regardless whether or not they resulted in a contract between the parties. In a preferred embodiment, selected parts of this database may be viewed by parties to the negotiation.

In a preferred embodiment, all of these steps are dynamically driven by a computerized negotiation engine, so as to occur in real time.

### BRIEF DESCRIPTION OF THE DRAWINGS

FIG. 1 shows a block diagram of a system for automated negotiation in a networking environment.

FIGS. 2A and 2B show a data flow diagram for a system for automated negotiation in a networking environment.

FIG. 3 is a block diagram showing the structure of the database used in a system for automated negotiation in a networking environment.

### DETAILED DESCRIPTION OF THE PREFERRED EMBODIMENT

In the following description, a preferred embodiment of the invention is described with regard to preferred process steps and data structures. Those skilled in the art would recognize after perusal of this application that embodiments of the invention can be implemented using one or more general purpose processors or special purpose processors or other circuits adapted to particular process steps and data structures described herein, and that implementation of the process steps and data structures described herein would not require undue experimentation or further invention.

### Lexicography

As used herein, use of the following terms refer or relate to aspects of the invention as described below.
electronic or automated negotiation—as used herein, the phrase “electronic negotiations” or “automated negotiations” includes negotiations that are conducted using a server device to transmit information between the parties. In a preferred embodiment, the parties to such negotiations may be individuals, entities or automated agents acting on behalf of a party.
initiating party—as used herein, the phrase “initiating party” includes the party who begins the negotiation process by setting parameters that describe a possible desired outcome. The initiating party uses a computerized communication system to transmit these parameters to prospective negotiating parties for review and response.
prospective negotiating party—as used herein, the phrase “prospective negotiating party” includes all parties who receive invitations to negotiate from an initiating party. Possible prospective negotiating parties include (but are not limited to) those parties listed in a directory used in identifying prospective negotiating parties. The identity of prospective negotiating parties may be known or unknown to the negotiating party.
participants—as used herein the phrase “participants” refers to the subset of prospective negotiating parties who are active participants in an ongoing negotiation.
invitation—as used herein the phrase “invitation” includes all expressions of willingness to negotiate made by the initiating party. In a preferred embodiment, invitations may include parameters describing the nature of the negotiation and possible desired outcomes.
directory—as used herein, the phrase “directory” includes a list of entities that qualify as prospective negotiating parties. An initiating party may review the directory and select parties with whom he wishes to negotiate.
transaction—as used herein, the phrase “transaction” includes any step in a negotiation. For example, a transaction may include making an offer, making a counteroffer, chat regarding an offer and other interactions between the parties. Unlike conventional terminology, “transaction” does not refer to a course of dealings in its entirety, but only a part thereof.
closing a deal—as used herein, the phrase “closing a deal” refers to the culmination of a series of transactions. In a preferred embodiment, this involves agreement between the initiating party and participants as to multiple parameters involved in the negotiation.
structured message object—as used herein, the phrase “structured message object” refers to the communication included in a transaction. The specific structure of the message object depends on the type of communication. In a preferred embodiment, the structure of a message object is a data packet.
instrument—as used herein, the phrase “instrument” refers to the nature of the property or service being negotiated. Examples of instruments include shipping contracts, leases and security trades. One of the first steps in using the invention is defining what type of instrument is being negotiated.
multi-variable negotiations—as used herein, the phrase “multi-variable negotiations” includes negotiations in which more than one parameter may be varied. For example, negotiations for transporting goods may involve changing any of the following parameters: price, pick-up dates, delivery dates, speed of transport, container provision, off-loading and insurance.
rating—as used herein, the phrase “rating” involves an evaluation of an entity with respect to quality of product and service, timeliness, responsiveness, flexibility and billing that is made by parties who have participated in negotiations and closed a deal with the entity being rated.
summarization and aggregation—as used herein, the phrase “summarization and aggregation” includes all techniques and methodologies for the organization, selective or nonselective segregation, linking, selective presentation and selective transfer of information included in one or more bids that are presented to an initiator of a negotiation. Information exchanged in real-time messaging, chat and various customized negotiations can also be summarized and aggregated. This phrase also describes the treatment of data presented to parties transacting with the initiator.
client device—as used herein, the phrase “client device” includes any combination of devices or software taking on the role of a client in a client-server environment in the Internet, the World Wide Web, or an equivalent or extension thereof. There is no particular requirement that the client devices must be individual devices. They can each be a single device, a set of cooperating devices, a portion of a device, or some combination thereof (such as for example a device providing web server services that acts as an agent of the user).
universal commerce server—is a device that takes on the role of a server in a client-server relationship and has access to a database and a computer program that is used to facilitate multi-variable negotiations. In a preferred embodiment, the universal commerce server (combined with the program and database) acts as a negotiation engine. There is no particular requirement that server devices must be individual physical devices; they can each be a single device, a set of cooperating devices, a portion of a device, or some combination thereof.
web site—As used herein, the phrase “web site” includes any combination of devices or software taking on the role of a server in a client-server environment in the Internet, the world wide web, or an equivalent or extension thereof.
e-commerce or electronic commerce—As used herein, the phrase “ecommerce” or “electronic commerce” includes all commercial, business, professional and investment activities conducted over the Internet, an intranet or any type of network.

### System Elements

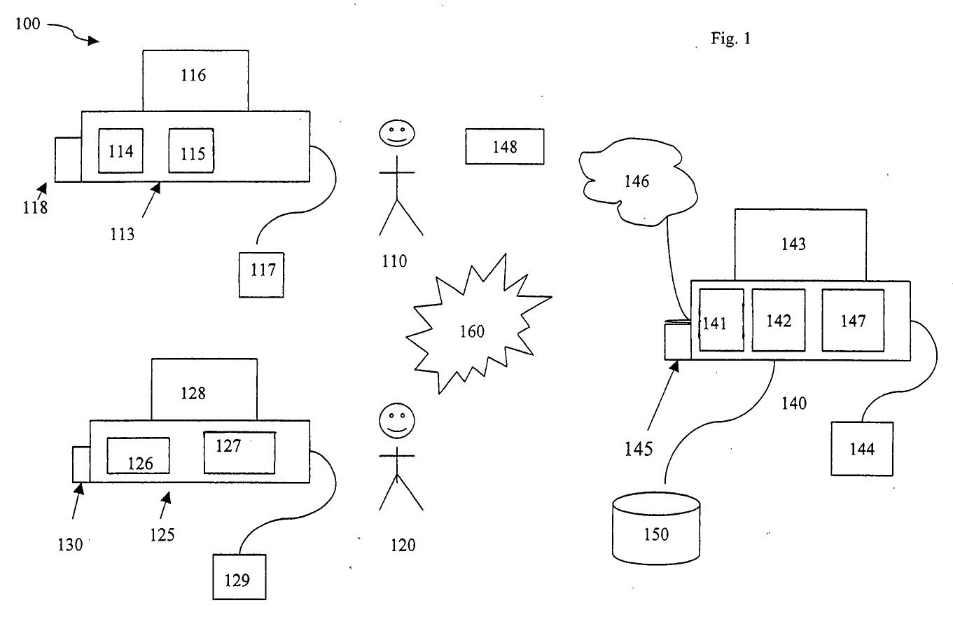

FIG. 1 shows a block diagram of a system for automated negotiation in a networking environment.

A system for automated negotiations in a networking environment is shown by general character reference 100. A system 100 includes at least one initiating party 110, a client device 113 under the control of each initiating party 110, one or more prospective negotiating parties 120, a client device 125 under the control of each of the one or more prospective negotiating parties 120, a server 140, and a communication network 160.

The initiating party 110 is an individual who starts a negotiation with others. The designation “initiating party” is specific to a particular transaction. For example, an individual may be an initiating party 110 in one particular transaction and a prospective negotiating party in a different transaction.

The client device 113 includes a computer having a processor 114, mass storage (or memory) 115, a presentation element 116, an input element 117 and a network connection 118 capable of being coupled to communication link 160. As used herein, the term “computer” is intended in its broadest sense, and includes any device having a programmable processor or otherwise falling within the generalized Turing machine paradigm such as a personal computer, laptop or personal digital assistant. In different embodiments, the network connection 118 may be a modem coupled to a digital subscriber line, a modem coupled to an analog telephone line, a cable modem, wireless connection or other device for accessing the communication network 160.

The one or more prospective negotiating parties 120 include individuals who are also interested in a negotiating with others. In a preferred embodiment, the prospective negotiating parties 120 are selected by the initiating party 110. If a particular prospective negotiation party 120 indicates that they want to participate in a particular negotiation, then the prospective negotiating party 120 becomes a participant 121 (not shown). Similar to the initiating party 110, a prospective negotiating party 120 and participant 121 are associated with a specific transaction being conducted. In a preferred embodiment, the prospective negotiating parties 120 and participants 121 in a particular negotiation may be the initiating party in another negotiation.

Similar to the client device 113, the client device 125 includes a computer having a processor 126, mass storage 127, a presentation element 128, an input element 129 and a network connection 130 capable of being coupled to communication link 160. Similar to the network connection 118, the network connection 130 may include a modem coupled to a digital subscriber line, a modem coupled to an analog telephone line, a cable modem, wireless transmitter or other device for accessing a network.

The server 140 includes a computer having a processor 141, mass storage 142, a presentation element 143, an input element 144 and a network connection 145 coupled to the communication link 160. Generally, the server 140 has sufficient processing power and communication bandwidth so as to host a web site 146 and manage multiple simultaneous transactions. In addition to these elements, the server 140 also includes a computer program 147 and a database 150.

The computer program 147 generates invitations 148, aggregates data received in response to those invitations 148 and generates interactive responses based upon information received from the initiating party 110, prospective negotiating parties 120 or participants 121.

In a preferred embodiment, invitations 148 to negotiations are sent from an initiating party 110 to one or more prospective parties 120. The interactive responses to these invitations 148 can be customized for particular types of negotiations or for particular types of businesses. For example, the computer program 147 can be customized to generate appropriate responses for shippers, merchants involved in the sale of fungible or non fungible goods, service providers and entities concerned with real property transactions

The database 150 includes various records 151 of each negotiation and a directory 152 of prospective negotiating parties 120.

The communication network 160 is disposed for communicating data between the client device 113, client device 125 and the server 140. In a preferred embodiment, the communication network 160 includes a packet switched network such as the Internet, as well as (in conjunction with or instead of) an intranet, an enterprise network, an extranet, a virtual private network or a virtual switched network. In alternative embodiments, the communication network 160 may include any other set of communication links that couple the client device 113, the client device 125 and the server 140.

### Method of Use

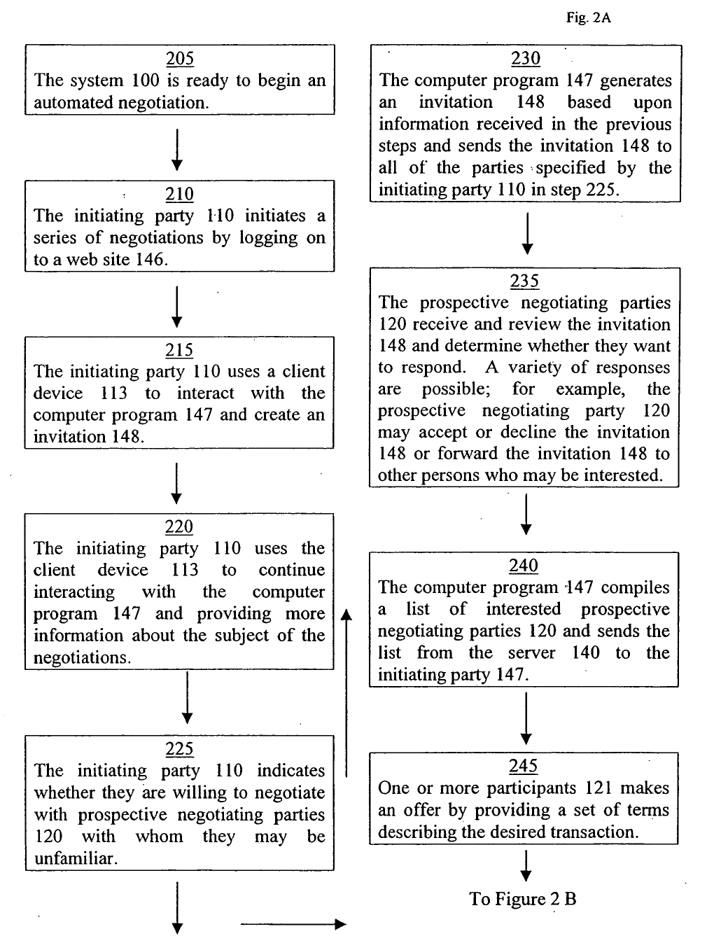

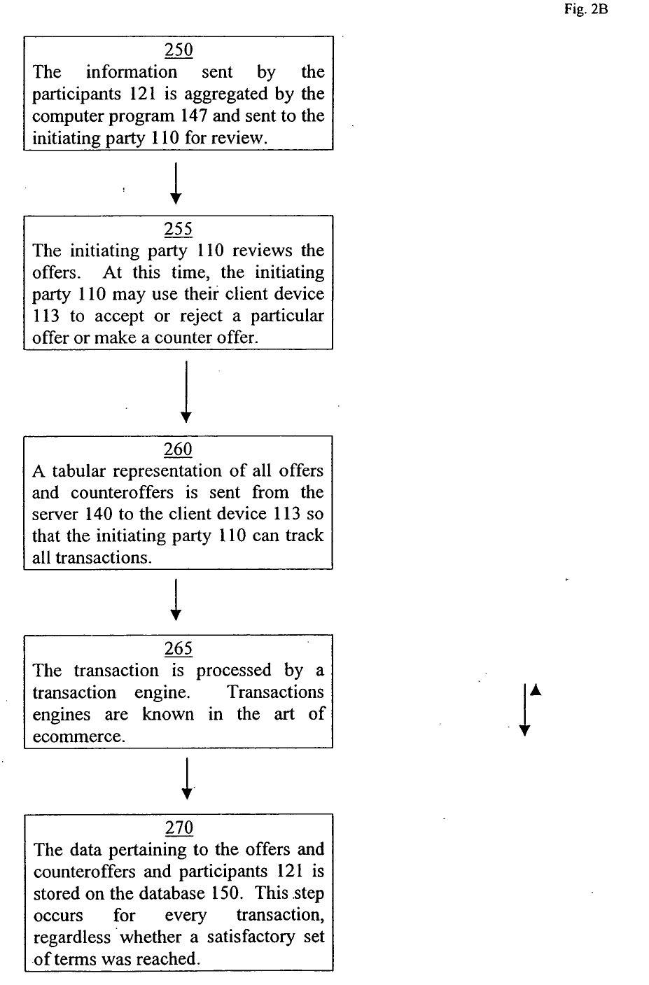

FIGS. 2A and 2B show a process flow diagram for a method of using a system for automated negotiation in a networking environment.

The method 200 is performed by the system 100. Although the method 200 is described serially, the steps of the method 200 can be performed by separate elements in conjunction or parallel, whether asynchronously, in a pipelined manner, or otherwise. There is no particular requirement that the method 200 be performed in the same order in which this description lists the steps, except where so indicated.

At a flow point 205, the system 100 is ready to begin an automated negotiation.

In a step 210, the initiating party 110 initiates a series of negotiations by logging on to a web site 146.

In a step 215, the initiating party 110 uses a client device 113 to interact with the computer program 147 and create an invitation 148. In a preferred embodiment, this step may be carried out using a transaction wizard. The initiating party 110 provides preliminary information regarding the general type of transaction which they wish to pursue (for example: a service contract, a real property lease, a securities exchange or other type of transaction) and the initiating party's status in the negotiation (for example: buyer, seller, lessor, lessee, etc.) and other information relating to possible terms for the transaction.

In a step 220, the initiating party 110 uses the client device 113 to continue interacting with the computer program 147 and providing more information about the subject of the negotiations. Each interaction is responsive to the step that proceeded it. For example, if in step 215 the initiating party 110 identified themselves as a buyer of real property, subsequent steps would be customized to describe real property negotiations rather than negotiations involving fungible goods. The initiating party 110 may also provide information related to their flexibility in entertaining counteroffers. For example, someone looking to lease office space may place limits with respect to the overall size of the office or it's proximity to a particular airport.

In a step 225, the initiating party 110 indicates whether they are willing to negotiate with prospective negotiating parties 120 with whom they may be unfamiliar. If the initiating party 110 is willing to interact with possibly unfamiliar prospective parties 120, then the negotiation is designated as a “public transaction”. Information concerning public transactions is widely broadcast to others who are listed in a directory stored on the database 150. If the initiating party 110 does not wish to interact with possibly unfamiliar prospective parties, then the transaction is designated as a “private transaction”. In private transactions, the initiating party 110 provides the names of specific parties with whom they wish to negotiate. These specific parties may or may not be listed in the directory. If they are not listed in the directory, the initiating party 110 provides sufficient contact information, such as a name and email address.

In a step 230, the computer program 147 generates an invitation 148 based upon information received in the previous steps and sends the invitation 148 to all of the parties specified by the initiating party 110 in step 225. If it is a public transaction, the invitation 148 is sent to all parties who have a commonality of interest. This commonality of interest is established by looking to information provided by the initiating party 110 in steps 210 and 215. The invitation 148 includes sufficient information so as to help a prospective negotiating party 120 decide whether they are interesting in pursuing a particular negotiation. This information generally includes the type of transaction, the identity of the initiating party 110, a transaction number, a deadline for responses and other related information related to possible terms of the transactions. These terms may include a number of different parameters of the transactions which may be fixed or open to negotiation.

In a step 235, the prospective negotiating parties 120 receive and review the invitation 148 and determine whether they want to respond. A variety of responses are possible; for example, the prospective negotiating party 120 may accept or decline the invitation 148 or forward the invitation 148 to other persons who may be interested. By accepting the invitation, the prospective negotiating party 120 is expressing their interest in negotiating; they are not accepting an offer or otherwise committing themselves. The prospective parties 120 use their associated client devices 125 to interact with the commerce server and signal their interest.

In a step 240, the computer program 147 compiles a list of interested prospective negotiating parties 120 and sends the list from the server 140 to the initiating party 147. This list may be refreshed if new parties express an interest in the transaction. At this step, the prospective negotiating parties 120 become participants 121. Ratings of these participants 121 are included in this list. The ratings are responsive to information from other people who have conducted business with the participants 121 in the past. The relative integrity of these ratings is insured because ratings do in not involve information from parties have not conducted business with each another.

In a step 245, one or more participants 121 makes an offer by providing a set of terms describing the desired transaction. For example, if an initiating party 110 used has expressed an general interest in leasing commercial space, a party making an offer may provide information as to the type of property they are offering (commercial warehouse space), the price ($80.00/square foot), the type of contract (10 year lease) as so forth. This information is sent to the server 140. Individual participants 121 may also send text messages or other information relating to the transaction.

In a step 250, the information sent by the participants 121 is aggregated by the computer program 147 and sent to the initiating party 110 for review. In a preferred embodiment, the information sent to the initiating parties 110 includes the names of the participants 121, the terms proposed by the participants 121 and the time and date that the offer was made. The information from the participants 121 is aggregated by the computer program 147 and presented to the initiating party 110 in tabular form that effectively summarizes all possible transactions, thereby making it relatively easy for the initiating party 110 to review possible options.

In a step 255, the initiating party 110 reviews the offers. At this time, the initiating party 110 may use their client device 113 to accept or reject a particular offer or make a counter offer. In a preferred embodiment, the counteroffer may be composed by altering one or more of the proposed terms. Additional text notes or other messages may accompany the counteroffer, further explaining the position of the initiating party 110. In this way, it is easy to negotiate with numerous parties simultaneously, in real time. Responses are sent to the server 140, which relays them to the appropriate participant 121. The confidentiality of the participants is maintained throughout the method 200. The identity of each participant 121 remains unknown to all other participants 121. Similarly, the nature of offers and counteroffers involving other participants 121 is not publicly known.

In a step 260, a tabular representation of all offers and counteroffers is sent from the server 140 to the client device 113 so that the initiating party 110 can track all transactions. This tabular representation summarizes the participants 121, the offers that have been made and the counteroffers (if any) made in response thereto, and a rating of the participant 121. Steps 245-260 may be repeated until either the initiating party 110 arrives at a set of satisfactory terms or abandons the negotiation. If the initiating party 110 decides to terminate negotiations, the method 200 proceeds at step 270; if a set of satisfactory terms is arrived, at the method 200 proceeds at step 265.

In a step 265, the transaction is processed by a transaction engine. Transactions engines are known in the art of ecommerce.

In a step 270, the data pertaining to the offers and counteroffers and participants 121 is stored on the database 150. This step occurs for every transaction, regardless whether a satisfactory set of terms was reached. If a set of satisfactory terms was arrived at the method 200 proceeds to step 270. If a set of satisfactory terms is not arrived at, the method 200 is terminated until such time that a new negotiating session begins.

In a preferred embodiment, the method 200 may be practiced a single time, multiple times or simultaneously by numerous parties.

### Database Schema

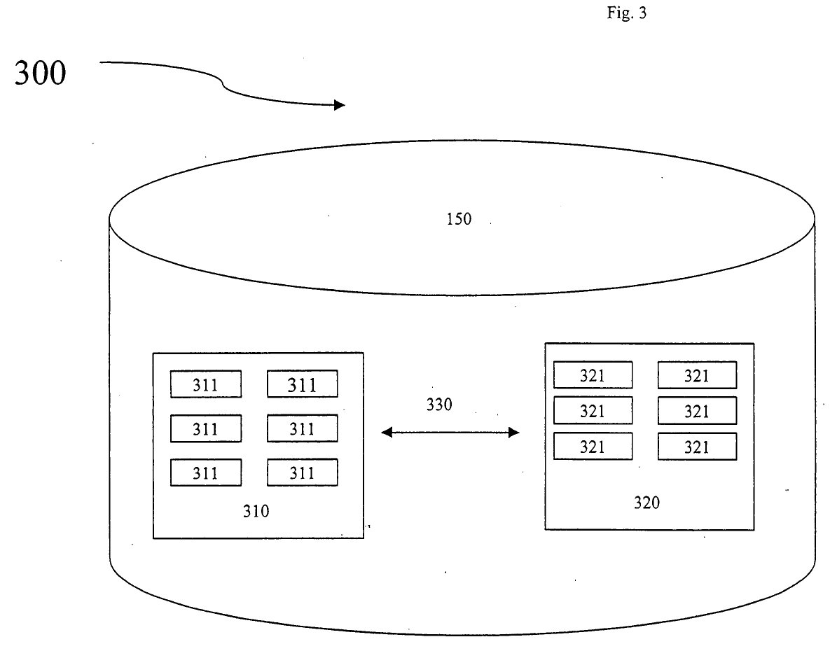

FIG. 3 is a block diagram showing the structure of the database used in a system for automated negotiation in a networking environment.

The database 150 is organized using a database scheme 300, having a set of tables and a set of relations between pairs of said tables. Although in a preferred embodiment, the database scheme 300 is used with a relational database (such as available from Oracle or Informix) there is no particular requirement that the database must be a relational database. In alternative embodiments the database may be an object-oriented database or another type of database. These alternative embodiments may or may not include a set of relations between tables.

A directory portion of the database scheme 300 includes a table 310 for each prospective negotiation party 120. Each table 310 includes data fields 311 for factors such as business name, address, telephone, type of business, ratings and other information related to prospective negotiating parties 120. The number of data fields 311 shown in the figure is exemplary, and in no way limiting.

A transaction portion of the database 300 includes a table 320 for each negotiation that has occurred. Each table 310 for a negotiation includes a set of data fields 321 detailing participants 121 to the transaction, dates and time that offers that were made, dates and times that counteroffers that were made, terms of offers, terms of counteroffers, terms that were accepted, terms that were rejected, ratings of the participants, and text and other fields that were exchanged.

A set of relations 330 can be used to associate data fields 311 in the directory table 310 with the data fields 321 in a particular transaction table 320. Thus, it is possible to identify all negotiations with a particular initiating party 110. The set of relations 330 also allows other participants 121 to access specific fields of the transaction that apply to them. Participants 121 may generally not access fields 321 that do not apply to them. In this way, information concerning a particular transaction remains confidential.

### Alternative Embodiments

Although preferred embodiments are disclosed herein, many variations are possible which remain within the concept, scope, and spirit of the invention, and these variations would become clear to those skilled in the art after perusal of this application.

1. An apparatus for automated negotiation, including
a server, including a computer program that acts as a negotiation engine;
a database, including a directory of prospective negotiating parties;
a first client device, under the control of a first party who initiates said automated negotiation;
one or more second client devices under the control of one or more second parties; and
a communication system.

2. An apparatus as in claim 1, wherein said computer program includes a first instruction to selectively associate one or more entries in said database with information provided by said first party, so as to create an invitation to a particular said automated negotiation.

3. An apparatus as in claim 2, including a means for sending said invitation to said one or more second parties.

4. An apparatus as in claim 1, wherein said computer program includes a second instruction to compile terms suggested by said one or more second parties.

5. An apparatus as in claim 4, including a means for presenting said compiled terms in a tabular form to said first party.

6. An apparatus as in claim 1, including a means for transmitting a response from said first party regarding information by said second party in real time.

7. An apparatus as in claim 1, wherein said communication system includes a wireless transmitter and receiver.

8. An apparatus as in claim 1, wherein said database is a relational database.

9. An apparatus as in claim 1, wherein said database is an object-oriented database.

10. A method for automated negotiation, including steps for
identifying one or more parties;
setting the parameters of said automated negotiation;
sending an invitation to said automated negotiation to one or more parties;
making an offer in response to said invitation;
responding to said offer;
storing information in a database.

11. A method as in claim 10, wherein said step of identifying prospective partners is performed automatically by a computer program that searches a database.

12. A method as in claim 10, wherein said step of identifying prospective partners is performed by the initiator of said automated negotiation.

13. A method as in claim 10 wherein said step of identifying prospective partners includes setting various parameters for access control and preferences so as to create private negotiations and private directories.

14. A method as in claim 10, wherein said step of setting the parameters is performed by an initiator of said automated negotiation through a series of interactions with a computer program.

15. A method as in claim 14, wherein said series of interactions includes
defining the type of said automated negotiation;
specifying terms that can be varied; and
specifying a range over which said terms can be varied.

16. A method as in claim 10, wherein said invitation includes information included in said parameters.

17. A method as in claim 10, wherein said invitation is sent to said one or more parties using a computerized communication system.

18. A method as in claim 17, wherein said computerized communication system includes a wireless transmitter and receiver.

19. A method as in claim 10, wherein said step of making an offer is performed by a party other than the sender of said invitation.

20. A method as in claim 10, wherein said step of responding to said offer includes accepting the offer, rejecting the offer or making a counter offer.

21. A method as in claim 10, wherein said step of responding is performed by the party that sent said invitation.

22. A method as in claim 10, wherein said step of storing information includes information concerning said automated negotiation.

23. A method as in claim 10, wherein said step of storing information includes information regarding the relative performance of one or more parties to said automated negotiation.

24. A method as in claim 10, wherein said step of storing information is independent of any particular outcome of said automated negotiations.

25. A method as in claim 10, wherein said information is stored on a relational database.

26. A method as in claim 10, wherein said information is stored on an object-oriented database.
